(19) United States
(12) Patent Application Publication
(10) Pub. No.: US 2026/0213780 A1
(43) Pub. Date: Jul. 23, 2026

(54) ISOLATION INTEGRATED CIRCUIT AND COMPENSATION CIRCUIT THEREOF

(71) Applicant: PowerX Semiconductor Corporation, Hsinchu County (TW)

(72) Inventors: Jo-Yu WANG, Hsinchu County (TW); Chih-Yuan HSU, Hsinchu County (TW)

(21) Appl. No.: 19/227,531

(22) Filed: Jun. 4, 2025

(30) Foreign Application Priority Data
Jan. 23, 2025 (TW) 114103164

(51) Int. Cl. H04B 1/04; H04B 1/12

(52) U.S. Cl. CPC H04B 1/0475; H04B 1/12

(57) ABSTRACT

The present disclosure provides an isolation integrated circuit and a compensation circuit thereof. The isolation integrated circuit includes an isolation capacitor and a signal processing circuit. The compensation circuit is coupled to the isolation capacitor and the signal processing circuit. The compensation circuit includes a compensation resistor and a compensation capacitor. The compensation resistor is coupled to the isolation capacitor at a first node, and is coupled to a ground terminal. The compensation capacitor is coupled to the isolation capacitor and the compensation resistor at the first node, and is coupled to the signal processing circuit, wherein the compensation capacitor and the isolation capacitor share a metal plate.

### RELATED APPLICATIONS

This application claims priority to Taiwan Application Serial Number 114103164, filed, January 23, 2025, which is herein incorporated by reference.

### BACKGROUND

### Field of Disclosure

The present disclosure relates to a compensation circuit, and particularly relates to a compensation circuit applicable to an isolation integrated circuit.

### Description of Related Art

In the related fields of an isolation gate driver, some events, such as common mode transient (CMT), often occur. Some related arts respond to a steep rise or drop in the voltage due to CMT by adding additional circuits into the isolation gate driver. However, these additional circuits cause excessive parasitic capacitors in the isolation gate driver, which affects the signals transmitted by the isolation gate driver. Therefore, it is necessary to propose new approaches to address the above problems.

### SUMMARY

An embodiment of the present disclosure is a compensation circuit. The compensation circuit is coupled to an isolation capacitor and a signal processing circuit, and includes a compensation resistor and a compensation capacitor. The compensation resistor is coupled to the isolation capacitor at a first node, and is coupled to a ground terminal. The compensation capacitor is coupled to the isolation capacitor and the compensation resistor at the first node, and further coupled to the signal processing circuit, wherein the compensation capacitor and the isolation capacitor share a metal plate.

An embodiment of the present disclosure is a compensation circuit. The compensation circuit is coupled to an isolation capacitor and a signal processing circuit, and includes a compensation resistor and a compensation capacitor. The compensation capacitor includes a first metal plate and a second metal plate, wherein the first metal plate is coupled to the signal processing circuit, and the compensation capacitor and the isolation capacitor share the second metal plate. The compensation resistor is coupled to the second metal plate at a first node, and is coupled to a ground terminal.

An embodiment of the present disclosure is an isolation integrated circuit. The isolation integrated circuit includes a signal processing circuit, an isolation capacitor and a compensation circuit. The signal processing circuit is coupled to a first input/output terminal. The isolation capacitor includes a first metal plate and a second metal plate, wherein the first metal plate is coupled to a second input/output terminal. The compensation circuit is coupled to the isolation capacitor and the signal processing circuit, and includes a compensation capacitor and a compensation resistor. The compensation capacitor includes the second metal plate and a third metal plate, wherein the third metal plate is coupled to the signal processing circuit. The compensation resistor is coupled to the second metal plate at a first node, and is coupled to a ground terminal.

In sum, by providing the compensation circuit between the isolation capacitor and the signal processing circuit, the isolation integrated circuit of the present disclosure can efficiently perform a current compensation at the first node when the CMT event occurs. In addition, in comparison to some related arts allowing a capacitor used as the electrical isolation barrier and another capacitor in a circuit providing the current compensation to not share one metal plate, the isolation integrated circuit of the present disclosure has advantages of less parasitic capacitors, high reliability, efficient transmission, etc.

### BRIEF DESCRIPTION OF THE DRAWINGS

FIG. 1 is a block diagram of a compensation circuit in accordance with some embodiments of the present disclosure;

FIG. 2 is a circuit block diagram of an application of a compensation circuit to an isolation integrated circuit in accordance with some embodiments of the present disclosure;

FIG. 3 is a circuit block diagram of another application of a compensation circuit to an isolation integrated circuit in accordance with some embodiments of the present disclosure;

FIG. 4 is a circuit block diagram of yet another application of a compensation circuit to an isolation integrated circuit in accordance with some embodiments of the present disclosure; and

FIG. 5 is a schematic diagram of the structures of a compensation capacitor and an isolation capacitor in accordance with some embodiments of the present disclosure.

### DETAILED DESCRIPTION

The following is a detailed description of embodiments in conjunction with the drawings. However, the specific embodiments described are only intended to explain the present disclosure, rather than to limit the present disclosure. The description of structural operations is not used to limit the order of execution thereof. Devices with equal effects, structurally formed by the recombination of elements, are all within the scope of the present disclosure.

Terms used throughout the specification and the claims of the present disclosure, unless otherwise specified, generally have the ordinary meaning of each term used in the art, in the present disclosure and in special contents.

The term “coupled” or “coupled” used herein may indicate that two or more elements are in direct physical or electrical contact with each other, or that two or more elements are in indirect physical or electrical contact with each other, and also may indicate that two or more elements co-operate or interact with each other.

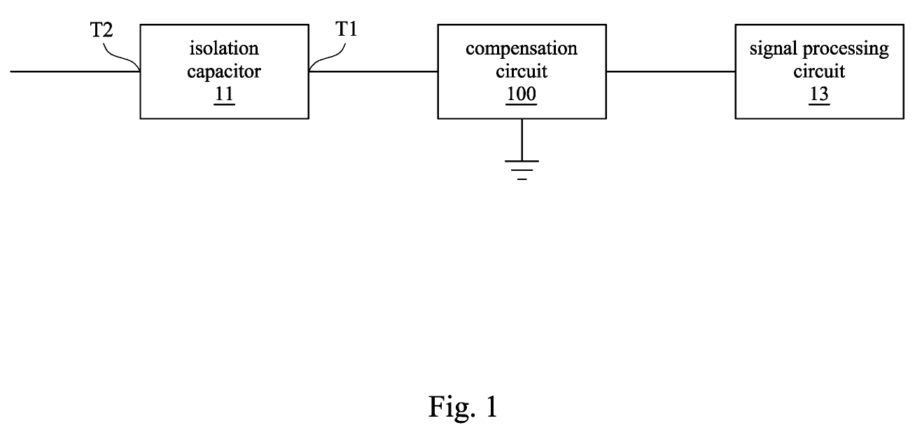

Referring to FIG. 1, FIG. 1 is a block diagram of a compensation circuit 100 in accordance with some embodiments of the present disclosure. As shown in FIG. 1, the compensation circuit 100 is coupled to an isolation capacitor 11 and a signal processing circuit 13.

In some embodiments, a voltage level at a first terminal T1 of the isolation capacitor 11 may need to increase or decrease due to some non-ideal factors (e.g., a steep rise or a steep drop in a voltage level at a ground terminal). The change in the voltage level at the first terminal T1 may not instantly respond to the change in the voltage level at the ground terminal, such that an unexpected voltage difference is generated between the first terminal T1 and the ground terminal. The voltage difference may affect a second terminal T2 of the isolation capacitor 11 (through coupling) and/or the signal processing circuit 13. For example, in order to eliminate the voltage difference, charging current or discharging current may be generated between the first terminal T1 and the ground terminal, and a power supply of the signal processing circuit 13 coupled to the ground terminal may be affected by the charging current or the discharging current. In the embodiments of FIG. 1, the compensation circuit 100 can perform a current compensation at the first terminal T1 of the isolation capacitor 11 during the steep rise or the steep drop in the voltage level at the ground terminal.

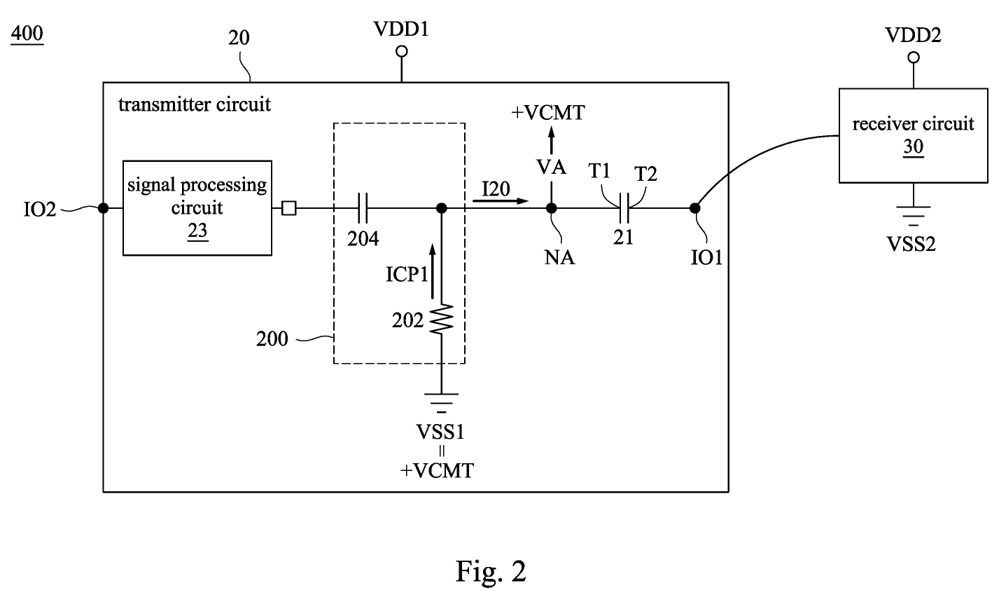

Referring to FIG. 2, FIG. 2 is a circuit block diagram of an isolation integrated circuit 400 in accordance with some embodiments of the present disclosure. In some embodiments, the isolation integrated circuit 400 includes a transmitter circuit 20 and a receiver circuit 30. In particular, the isolation integrated circuit 400 can be implemented by an isolation gate driver.

In some embodiments, an electrical isolation barrier is provided between the transmitter circuit 20 and the receiver circuit 30. Therefore, the transmitter circuit 20 and the receiver circuit 30 can be operated in two different voltage domains, respectively. For example, as shown in FIG. 2, the transmitter circuit 20 can be biased by a voltage at a power terminal VDD1 and a voltage at a ground terminal VSS1, and the receiver circuit 30 can be biased by a voltage at a power terminal VDD2 and a voltage at a ground terminal VSS2. In addition, the voltage at the power terminal VDD1 and the voltage at the power terminal VDD2 can be different from each other, and the voltage at the ground terminal VSS1 and the voltage at the ground terminal VSS2 can be different from each other.

In some embodiments, the compensation circuit 100 and the isolation capacitor 11 of FIG. 1 can be arranged in the transmitter circuit 20 or the receiver circuit 30, or can be arranged in both the transmitter circuit 20 and the receiver circuit 30, which would be described in detail below with reference to FIGS. 2-4.

In the embodiments of FIG. 2, the transmitter circuit 20 includes a signal processing circuit 23, a compensation circuit 200 and an isolation capacitor 21. The signal processing circuit 23 can be an example of the signal processing circuit 13 of FIG. 1, the compensation circuit 200 can be an example of the compensation circuit 100 of FIG. 1, and the isolation capacitor 21 can be an example of the isolation capacitor 11 of FIG. 1. In particular, the compensation circuit 200 includes a compensation resistor 202 and a compensation capacitor 204. The compensation resistor 202 is coupled to the first terminal T1 of the isolation capacitor 21 at a node NA and further coupled to the ground terminal VSS1. The compensation capacitor 204 is coupled to the first terminal T1 of the isolation capacitor 21 and the compensation resistor 202 at the node NA and further coupled to the signal processing circuit 23. In addition, the second terminal T2 of the isolation capacitor 21 is coupled to an input/output terminal IO1 of the transmitter circuit 20, and the signal processing circuit 23 is coupled to another input/output terminal IO2 of the transmitter circuit 20.

In some embodiments, the signal processing circuit 23 of the transmitter circuit 20 can be implemented by various circuits, such as logic circuit(s), oscillator(s), modulator(s), transmitter(s), etc. In such arrangements, the transmitter circuit 20 can modulate a signal (not shown in the drawings) received from the input/output terminal IO2 by the signal processing circuit 23, and can transmit the modulated signal to the receiver circuit 30 from the input/output terminal IO1 by the compensation circuit 200 and the isolation capacitor 21. In addition, the isolation capacitor 21 of the transmitter circuit 20 can be used as the electrical isolation barrier.

In some embodiments, a common mode transient (CMT) event may occur in the isolation integrated circuit 400. When the CMT event occurs, the voltage level at the ground terminal VSS1 may be steeply increased (or may steeply rise) to a positive voltage VCMT (which is presented as +VCMT in FIG. 2, in which the voltage VCMT ranges from a few volts to thousands of volts). At this time, the voltage difference between the voltage level at the ground terminal VSS1 and a voltage level of a voltage signal VA at the node NA (i.e., the voltage difference between the ground terminal VSS1 and the node NA) may exceed an expected value, thereby inducing a charging current I20 from the ground terminal VSS1 to the first terminal T1 (or the node NA). The charging current I20 is configured to cause the voltage level of the voltage signal VA to change towards the positive voltage VCMT. It should be understood that the charging current I20 can flow from the ground terminal VSS1 to the first terminal T1 through some circuits (e.g., the signal processing circuit 23) of the transmitter circuit 20 coupled to the ground terminal VSS1, so that the circuits coupled to the ground terminal VSS1 are affected.

In accordance with the above descriptions, the compensation circuit 200 also generates a compensation current ICP1, which is generated according to the voltage difference between the voltage level at the ground terminal VSS1 and the voltage level of the voltage signal VA and passes through the compensation resistor 202, to compensate the charging current I20 additionally. As the voltage level of the voltage signal VA approaches the positive voltage VCMT gradually, the compensation current ICP1 approaches zero eventually. As shown in FIG. 2, the compensation current ICP1 flows from the ground terminal VSS1 to the node NA through the compensation resistor 202. By the compensation current ICP1 flowing to the node NA, the current flowing through the circuits (e.g., the signal processing circuit 23) of the transmitter circuit 20 can be reduced, to eliminate or reduce the impacts on the circuits of the transmitter circuit 20. In brief, when the voltage level at the ground terminal VSS1 is steeply increased, the transmitter circuit 20 gradually increases the voltage level of the voltage signal VA by the charging current I20 compensated by the compensation current ICP1, to eliminate the voltage difference between the voltage level at the ground terminal VSS1 and the voltage level of the voltage signal VA. In addition, the compensation capacitor 204 isolates the signal processing circuit 23 from the node NA, so that the signal processing circuit 23 is not affected by the change in the voltage signal VA.

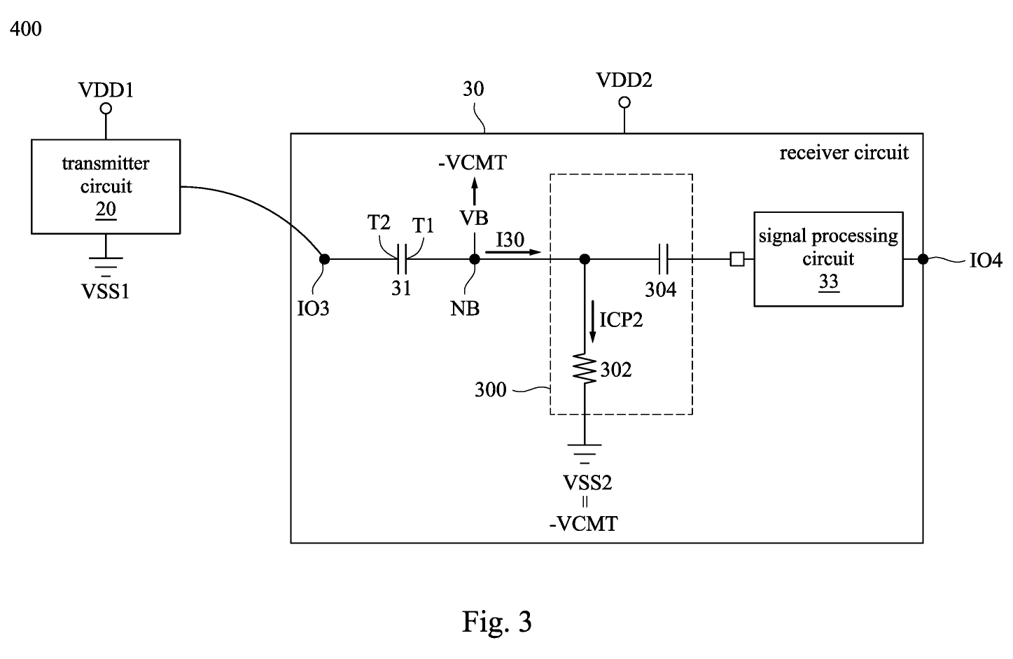

Referring to FIG. 3, FIG. 3 is another circuit block diagram of the isolation integrated circuit 400 in accordance with some embodiments of the present disclosure.

In the embodiments of FIG. 3, the receiver circuit 30 includes a signal processing circuit 33, a compensation circuit 300 and an isolation capacitor 31. The signal processing circuit 33 can be an example of the signal processing circuit 13 of FIG. 1, the compensation circuit 300 can be an example of the compensation circuit 100 of FIG. 1, and the isolation capacitor 31 can be an example of the isolation capacitor 11 of FIG. 1. In particular, the compensation circuit 300 includes a compensation resistor 302 and a compensation capacitor 304. The compensation resistor 302 is coupled to the first terminal T1 of the isolation capacitor 31 at a node NB and further coupled to the ground terminal VSS2. The compensation capacitor 304 is coupled to the first terminal T1 of the isolation capacitor 31 and the compensation resistor 302 at the node NB and further coupled to the signal processing circuit 33. In addition, the second terminal T2 of the isolation capacitor 31 is coupled to an input/output terminal IO3 of the receiver circuit 30, and the signal processing circuit 33 is coupled to another input/output terminal IO4 of the receiver circuit 30.

In some embodiments, the signal processing circuit 33 of the receiver circuit 30 can be implemented by various circuits, such as logic circuit(s), demodulator(s), receiver(s), etc. In such arrangements, the receiver circuit 30 can receive a signal (not shown in the drawings) from the transmitter circuit 20 by the input/output terminal IO3, transmit the signal by the compensation circuit 300, and demodulate the signal transmitted from the compensation circuit 300 by the signal processing circuit 33. The receiver circuit 30 outputs the demodulated signal from the input/output terminal IO4. In addition, the isolation capacitor 31 of the receiver circuit 30 can be used as the electrical isolation barrier.

When a CMT event occurs, the voltage level at the ground terminal VSS2 may be steeply decreased (or may steeply drop) to a negative voltage VCMT (which is presented as -VCMT in FIG. 3). At this time, the voltage difference between the voltage level at the ground terminal VSS2 and a voltage level of a voltage signal VB at the node NB (i.e., the voltage difference between the ground terminal VSS2 and the node NB) may exceed an expected value, thereby inducing a discharging current I30 from the first terminal T1 (or the node NB) to the ground terminal VSS2. The discharging current I30 is configured to cause the voltage level of the voltage signal VB to change towards the negative voltage VCMT. It should be understood that the discharging current I30 can flow from the first terminal T1 to the ground terminal VSS2 through some circuits (e.g., the signal processing circuit 33) of the receiver circuit 30 coupled to the ground terminal VSS2, so that the circuits coupled to the ground terminal VSS2 are affected.

In accordance with the above descriptions, the compensation circuit 300 also generates a compensation current ICP2, which is generated according to the voltage difference between the voltage level at the ground terminal VSS2 and the voltage level of the voltage signal VB and passes through the compensation resistor 302, to compensate the discharging current I30 additionally. As the voltage level of the voltage signal VB approaches the negative voltage VCMT gradually, the compensation current ICP2 approaches zero eventually. As shown in FIG. 3, the compensation current ICP2 flows from the node NB to the ground terminal VSS2 through the compensation resistor 302. By the compensation current ICP2 flowing from the node NB, the current flowing through the circuits (e.g., the signal processing circuit 23) of the receiver circuit 30 can be reduced, to eliminate or reduce the impacts on the circuits of the receiver circuit 30. In brief, when the voltage level at the ground terminal VSS2 is steeply decreased, the receiver circuit 30 gradually decreases the voltage level of the voltage signal VB by the discharging current I30 compensated by the compensation current ICP2, to eliminate the voltage difference between the voltage level at the ground terminal VSS2 and the voltage level of the voltage signal VB. In addition, the compensation capacitor 304 isolates the signal processing circuit 33 from the node NB, so that the signal processing circuit 33 is not affected by the change in the voltage signal VB.

From the descriptions of the embodiments of FIGS. 2 and 3, it can be seen that, when a CMT event occurs, the compensation circuit 100, in response to the voltage difference between the node NA and the ground terminal VSS1 (or the voltage difference between the node NB and the ground terminal VSS2) caused by the change in the voltage level at the ground terminal VSS1 (or the voltage level at the ground terminal VSS2), is configured to generate the compensation current ICP1 flowing to the node NA (or generate the compensation current ICP2 flowing from the node NB) by the compensation resistor 202 (or the compensation resistor 302), to achieve the current compensation at the node NA (or the node NB). By the charging current I20 compensated by the compensation current ICP1 (or the discharging current I30 compensated by the compensation current ICP2), the voltage signal VA at the node NA (or the voltage signal VB at the node NB) is also changed in response to the change in the voltage level at the ground terminal VSS1 (or the voltage level at the ground terminal VSS2), to eliminate the voltage difference between the voltage level of the voltage signal VA and the voltage level at the ground terminal VSS1 (or the voltage difference between the voltage level of the voltage signal VB and the voltage level at the ground terminal VSS2). In addition, when the voltage signal VA (or the voltage signal VB) is changed, the compensation circuit 100 is configured to isolate the signal processing circuit 13 from the node NA (or the node NB) by the compensation capacitor 204 (or the compensation capacitor 304), to prevent the signal processing circuit 13 from being affected by the voltage signal VA (or the voltage signal VB).

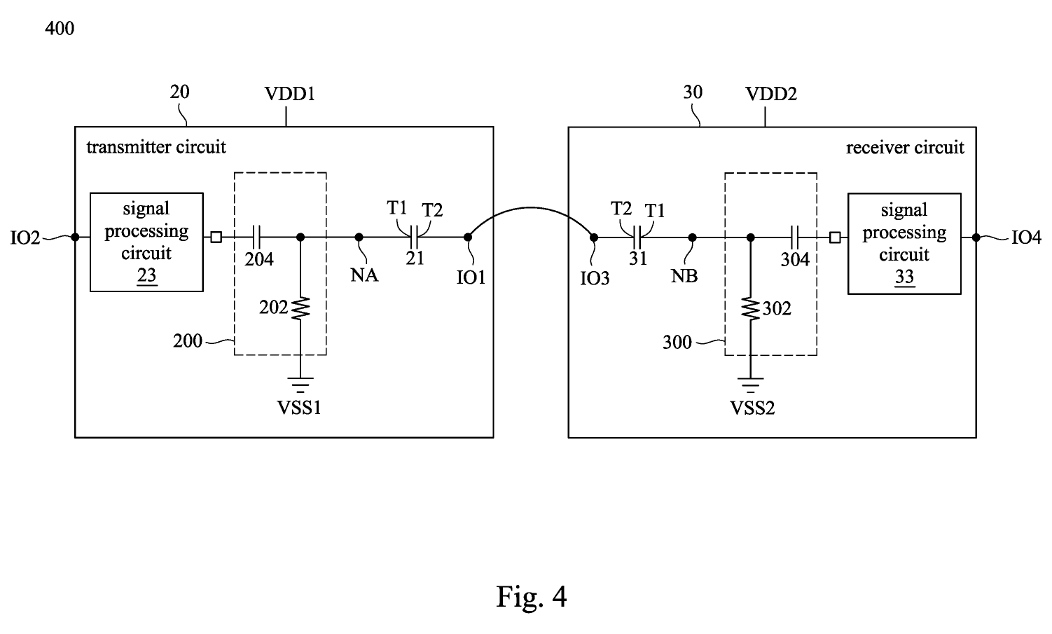

Referring to FIG. 4, FIG. 4 is yet another circuit block diagram of the isolation integrated circuit 400 in accordance with some embodiments of the present disclosure. In the embodiments of FIG. 4, the transmitter circuit 20 includes the signal processing circuit 23, the compensation circuit 200 and the isolation capacitor 21, and the receiver circuit 30 includes the signal processing circuit 33, the compensation circuit 300 and the isolation capacitor 31. That is to say, when a CMT event occurs, the transmitter circuit 20 can perform the current compensation by the compensation circuit 200, and the receiver circuit 30 can perform the current compensation by the compensation circuit 300. The configurations and operations of the transmitter circuit 20 and the receiver circuit 30 in FIG. 4 can refer to the embodiments of FIGS. 2 and 3, and therefore are omitted herein.

It should be understood that the transmitter circuit 20 and the receiver circuit 30 of the isolation integrated circuit 400 are not limited to the single ended transmission architecture as shown in FIGS. 2-4. In some embodiments, each of the transmitter circuit 20 and the receiver circuit 30 can be implemented with a differential transmission architecture. That is to say, the transmitter circuit 20 can include two input/output terminals IO1 and IO2 as shown in FIG. 2 and two other input/output terminals (not shown in the drawings), and there is also a circuit structure similar to the circuit structure composed of the isolation capacitor 21, the compensation circuit 200 and the signal processing circuit 23 as shown in FIG. 2 between the two other input/output terminals. Similarly, the receiver circuit 30 can include two input/output terminals IO3 and IO4 as shown in FIG. 3 and two other input/output terminals (not shown in the drawings), and there is also a circuit structure similar to the circuit structure composed of the isolation capacitor 31, the compensation circuit 300 and the signal processing circuit 33 as shown in FIG. 3 between the two other input/output terminals.

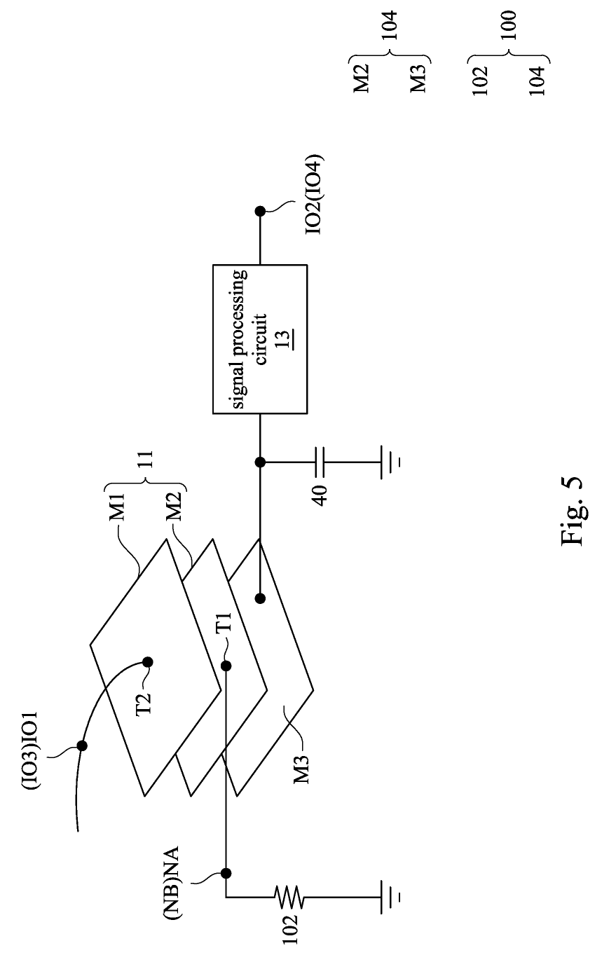

Referring to FIG. 5, FIG. 5 is a schematic diagram of the structures of the compensation circuit 100 and the isolation capacitor 11 in accordance with some embodiments of the present disclosure. In some embodiments, the compensation circuit 100 includes a compensation resistor 102 and a compensation capacitor 104. The isolation capacitor 11 is formed by a metal plate M1 and a metal plate M2 which are arranged in parallel, for example in the structure of Metal-Insulator-Metal (MIM) capacitor. The metal plate M1 is used as the second terminal T2 of the isolation capacitor 11, and the metal plate M2 is used as the first terminal T1 of the isolation capacitor 11. Moreover, the compensation capacitor 104 is formed by the metal plate M2 and a metal plate M3 arranged in parallel. From these descriptions, it can be seen that the isolation capacitor 11 and the compensation capacitor 104 share the metal plate M2.

In some further embodiments, the isolation capacitor 11 is used as the isolation capacitor 21 of the transmitter circuit 20 in FIG. 2, the isolation capacitor 31 of the receiver circuit 30 in FIG. 3, or each of the isolation capacitor 21 of the transmitter circuit 20 and the isolation capacitor 31 of the receiver circuit 30 in FIG. 4, to provide the electrical isolation barrier between the transmitter circuit 20 and the receiver circuit 30. There are K layers of metal plate between the metal plate M1 and the metal plate M2 of the isolation capacitor 11, in which K is a positive integer greater than 0. In other words, the isolation integrated circuit 400 further includes at least one metal plate (not shown in the drawings), and the at least one metal plate is arranged between the metal plate M1 and the metal plate M2. The metal plate M2 and the metal plate M3 are two adjacent layers. For example, the metal plate M2 is the upper layer or the lower layer of the metal plate M3, that is, the metal plates M2 and M3 are consecutively arranged. It should be understood that the arrangements of the metal plate M1, the metal plate M2 and the metal plate M3 are not limited herein by the present disclosure.

In the embodiments of FIG. 5, the metal plate M1 is coupled to the input/output terminal IO1 of FIG. 2 (or the input/output terminal IO3 of FIG. 3). The compensation resistor 102 is coupled to the metal plate M2 at the node NA of FIG. 2 (or the node NB of FIG. 3), and the metal plate M2 is coupled to the ground terminal (e.g., the ground terminal VSS1 of FIG. 2 or the ground terminal VSS2 of FIG. 3) through the compensation resistor 102. The signal processing circuit 13 is coupled to the metal plate M3 and further coupled to the input/output terminal IO2 of FIG. 2 (or the input/output terminal IO4 of FIG. 3).

In addition, in the structure as shown in FIG. 5, a parasitic capacitor 40 will be generated due to the metal plate M3. In particular, a first terminal of the parasitic capacitor 40 is coupled to the metal plate M3 and the signal processing circuit 13, and a second terminal of the parasitic capacitor 40 is coupled to the ground terminal. It should be understood that there may be other parasitic capacitors in the embodiments of FIG. 5, but the capacitances of these parasitic capacitors are significantly smaller than that of the parasitic capacitor 40 and thus can be ignored.

In some related arts, a capacitor used as the electrical isolation barrier and another capacitor in a circuit providing a current compensation do not share one metal plate, which results in the related arts generating more parasitic capacitors when using the circuit. In comparison to the related arts, the present disclosure provides the isolation capacitor 11 and the compensation capacitor 104 which share the metal plate M2, thereby significantly inhibiting the generation of parasitic capacitors. For example, compared to the equivalent parasitic capacitance of the isolation capacitor in the related arts, the equivalent parasitic capacitance of the isolation capacitor 11 in the isolation integrated circuit 400 using the compensation circuit 100 is reduced by approximately 80%. Furthermore, by reducing the equivalent parasitic capacitance, the amplitude of the signal transmitted by the isolation integrated circuit 400 can also be increased by about 20%, that is, the transmission loss of signal is reduced.

In accordance with the above embodiments of the present disclosure, by arranging the compensation circuit 100 between the isolation capacitor 11 and the signal processing circuit 13, the isolation integrated circuit 400 of the present disclosure can efficiently perform the current compensation at the node NA (or the node NB) when a CMT event occurs. In addition, the isolation integrated circuit 400 of the present disclosure has advantages of less parasitic capacitors, high reliability, efficient transmission, etc.

Although the present disclosure has been disclosed as above by way of the embodiments, these embodiments are not intended to limit the present disclosure. Those skilled in the art may make various changes and modifications without departing from the spirit and scope of the present disclosure. Therefore, the scope of protection of the present disclosure is to be determined as defined by the appended claims.

What is claimed is:

1. A compensation circuit, coupled to an isolation capacitor and a signal processing circuit, and comprising:
a compensation resistor, coupled to the isolation capacitor at a first node, and coupled to a ground terminal; and
a compensation capacitor, coupled to the isolation capacitor and the compensation resistor at the first node, and further coupled to the signal processing circuit, wherein the compensation capacitor and the isolation capacitor share a metal plate.

2. The compensation circuit according to claim 1, wherein the compensation circuit, in response to a voltage difference between the first node and the ground terminal caused by a steep rise or a steep drop in the ground terminal, is configured to generate a compensation current flowing to or from the first node by the compensation resistor.

3. The compensation circuit according to claim 2, wherein when the voltage difference is caused by the steep drop in the ground terminal, the compensation current flows from the first node to the ground terminal through the compensation resistor.

4. The compensation circuit according to claim 2, wherein when the voltage difference is caused by the steep rise in the ground terminal, the compensation current flows from the ground terminal to the first node through the compensation resistor.

5. The compensation circuit according to claim 2, wherein a voltage signal at the first node is changed in response to the steep rise or the steep drop in the ground terminal, and the compensation capacitor is configured to isolate the signal processing circuit from the first node when the voltage signal is changed.

6. The compensation circuit according to claim 1, wherein the compensation circuit, the isolation capacitor and the signal processing circuit are all arranged in a transmitter circuit of an isolation integrated circuit.

7. The compensation circuit according to claim 1, wherein the compensation circuit, the isolation capacitor and the signal processing circuit are all arranged in a receiver circuit of an isolation integrated circuit.

8. A compensation circuit, coupled to an isolation capacitor and a signal processing circuit, and comprising:
a compensation capacitor, comprising a first metal plate and a second metal plate, wherein the first metal plate is coupled to the signal processing circuit, and the compensation capacitor and the isolation capacitor share the second metal plate; and
a compensation resistor, coupled to the second metal plate at a first node, and coupled to a ground terminal.

9. The compensation circuit according to claim 8, wherein the compensation circuit, in response to a voltage difference between the first node and the ground terminal caused by a steep rise or a steep drop in the ground terminal, is configured to generate a compensation current flowing to or from the first node by the compensation resistor.

10. The compensation circuit according to claim 9, wherein when the voltage difference is caused by the steep drop in the ground terminal, the compensation current flows from the first node to the ground terminal through the compensation resistor.

11. The compensation circuit according to claim 9, wherein when the voltage difference is caused by the steep rise in the ground terminal, the compensation current flows from the ground terminal to the first node through the compensation resistor.

12. The compensation circuit according to claim 9, wherein a voltage signal at the first node is changed in response to the steep rise or the steep drop in the ground terminal, and the compensation capacitor is configured to isolate the signal processing circuit from the first node when the voltage signal is changed.

13. The compensation circuit according to claim 8, wherein the compensation circuit, the isolation capacitor and the signal processing circuit are all arranged in at least one of a transmitter circuit and a receiver circuit of an isolation integrated circuit.

14. The compensation circuit according to claim 8, wherein the first metal plate and the second metal plate are consecutively arranged.

15. An isolation integrated circuit, comprising:
a signal processing circuit, coupled to a first input/output terminal;
an isolation capacitor, comprising a first metal plate and a second metal plate, wherein the first metal plate is coupled to a second input/output terminal; and
a compensation circuit, coupled to the isolation capacitor and the signal processing circuit, and comprising:
a compensation capacitor, comprising the second metal plate and a third metal plate, wherein the third metal plate is coupled to the signal processing circuit; and
a compensation resistor, coupled to the second metal plate at a first node, and coupled to a ground terminal.

16. The isolation integrated circuit according to claim 15, wherein the compensation circuit, in response to a voltage difference between the first node and the ground terminal caused by a steep rise or a steep drop in the ground terminal, is configured to generate a compensation current flowing to or from the first node by the compensation resistor.

17. The isolation integrated circuit according to claim 15, wherein at least one metal plate is provided between the first metal plate and the second metal plate.

18. The isolation integrated circuit according to claim 15, wherein the second metal plate and the third metal plate are consecutively arranged.

19. The isolation integrated circuit according to claim 15, wherein the compensation circuit, the isolation capacitor and the signal processing circuit are all arranged in at least one of a transmitter circuit and a receiver circuit of the isolation integrated circuit.

20. The isolation integrated circuit according to claim 15, wherein the first metal plate and the second metal plate are arranged in parallel to form the isolation capacitor, and the second metal plate and the third metal plate are arranged in parallel to form the compensation capacitor.
